(19) United States
(12) Patent Application Publication
(10) Pub. No.: US 2007/0120000 A1
(43) Pub. Date: May 31, 2007

(54) Seat belt retractor including an energy absorbing device

(75) Inventor: Mark F. Gray, Sterling Heights, MI (US)

Correspondence Address: FOLEY AND LARDNER LLP;SUITE 500, 3000 K STREET NW, WASHINGTON, DC, 20007, US

(73) Assignee: TAKATA SEAT BELTS, INC.

(21) Appl. No.: 11/289,617

(22) Filed: Nov. 30, 2005

(51) Int. Cl. B60R 22/28

(52) U.S. Cl. 242/379.1

(57) ABSTRACT

A seat belt retractor comprising: a first and a second energy absorption mechanism which are triggered into lock positions once a sensor for detecting a vehicle characteristic initiates. The second energy absorption mechanism can be placed in a locked position by the movement of the first energy absorption mechanism being locked into a position by a locking mechanism. The second energy absorption mechanism can also deactivated by a controller. The energy absorbing mechanisms can be a torsion bar and a pre-bent member.

### BACKGROUND

The present invention generally relates to seat belt retractors having energy-absorbing or dissipating mechanisms and more particularly to a multi-level load-limiting system.

A classic seat belt retractor only offers a modest degree of energy absorption, which occurs as a relatively stiff seat belt stretches as it is loaded by the occupant during an emergency.

For decades, torsion bars have been proposed for use in seat belt retractors as an energy absorbing mechanism. As the torsion bar is twisted and, thus absorbing energy during a vehicle emergency, the torque or force displacement (rotation) characteristic of the torsion bar quickly reaches a saturated region, which corresponds to its plastic range of operation. This somewhat constant characteristic provides a reaction torque at the retractor and provides a reaction force or load on the seat belt, which retards and controls the manner by which the seat belt protracts from the spool. One level of reaction forces may not be adequate to protect occupants of differing sizes. Consequently, it is desirable to provide a seat belt system with more than one load-limiting characteristic or one that can be changed or changes as dynamic conditions change.

The prior art discloses seat belt retractors having two dissimilar and remotely located torsion bars to achieve a multi-level of load limiting, while other prior retractors use a single torsion bar that is sub-divided into two torsion bar portions to achieve multi-level load-limiting operation.

### SUMMARY

It is an object of the present invention to provide a multi-level energy-absorbing seat belt retractor.

In one embodiment, the retractor employs two energy absorbing (EA) mechanisms in which a sensor in the retractor initiates both mechanisms and a controller deactivates one of the mechanisms.

Another embodiment of the invention comprises two EA mechanisms in which one of the EA mechanism is triggered at about the same time by the other EA mechanism.

The first EA mechanism may include a torsion bar that generates a protective force for all occupants during low or high-speed crashes. The torsion bar reaction torque is set to a range as low as about 2 kN and as high as about 6 kN.

The second EA mechanism may include a pre-bent member, such as a flexible band. The band may be a high elongation metal wherein the energy is absorbed by a bending action as it is plastically deformed when rolled from the outer diameter to the inner diameter. This second EA mechanism generates a protective force when a 95th percentile occupant is using the system during frontal crashes at or above a first crash level. The default mode of operation of the invention is to use the pre-bent member.

As described below, one of the advantages of the invention is that the retractor is designed to automatically start off at a high level of energy absorption after the seat belt has been extended, such as during a crash. This advantage fulfills the need of providing a higher level of energy absorption during a high load impact event by using two EA mechanisms. The invention also may include a means for disabling the energy absorbing feature of the pre-bent member when an occupant of a slight size is using the seat belt system. More particularly, the invention may include a means for disabling the pre-bent member as a means for entering the torsion bar mode of operation. This aspect provides the advantage of sparing the pre-bent member mechanism of any detrimental effects due to its unnecessary use during a lower load impact.

One embodiment of the present invention utilizes the combination of the characteristics of a torsion bar and a pre-bent member to provide a multi-level seat belt load-limiting system.

It is to be understood that both the foregoing general description and the following detailed description are exemplary and exemplary only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a cross-sectional view, which illustrates many of the major components of an embodiment of the invention.

FIG. 2 shows an exploded view of many of the major components of an embodiment of the invention.

FIG. 3 is a schematic drawing of the safety restraint system that includes the retractor of the present invention.

FIGS. 4a-c are side views of the retractor when in an initial position before the crash event.

FIGS. 5a-c are side views of the retractor when the retractor is locked into position for a higher load crash event.

FIG. 6 is a side view of the retractor when the retractor is locked into position for a lower-load crash event.

### DETAILED DESCRIPTION OF THE DRAWINGS

By way of background, U.S. Pat. Nos. 6,863,235 and 6,106,013 are incorporated by reference herein in their entireties.

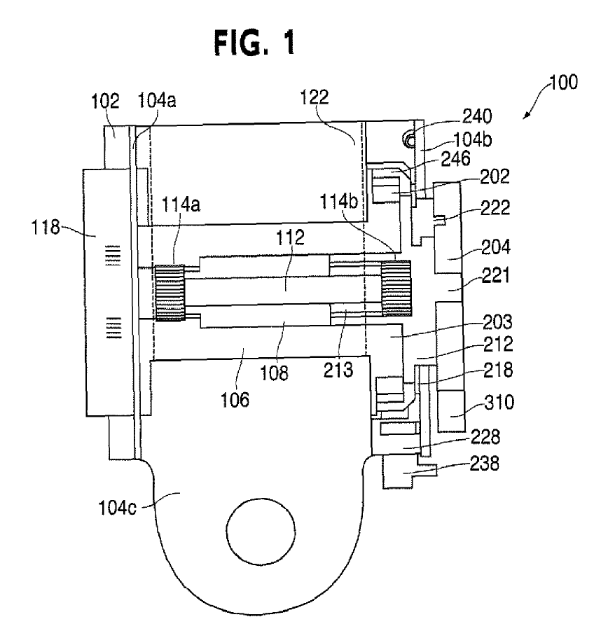

Reference is made to FIG. 1, which shows the major components of a seat belt retractor 100 incorporating the present invention. The retractor includes a frame 102 upon which a spool 106 is rotatably mounted between the sides 104a, 104b of the frame 102. The sides 104a, 104b are mounted on the back 104c of the frame 102. The spool 106 includes a central passage 108 for receipt of a torsion bar 112. The retractor 100 is an emergency locking retractor or ELR, which can be coupled to an optional automatically locking retractor or ALR switching mechanism.

The torsion bar 112 includes two ends 114a, 114b that have notches about their periphery. The spool 106 has a mating hole that has mating grooves, which allows the end 114a of the torsion bar 112 to be inserted in the spool's hole. This connection allows the spool 106 and the torsion bar 112 to rotate in unison. The end 114a of the torsion bar is also connected to a rewind spring 118 through a spring arbor. The spring arbor (not shown) is commonly used to connect the rewind spring 118 to the torsion bar 112. As the spool 106 is loaded, it twists the torsion bar 112 and rotates relative to the torsion bar. The twisting of the torsion bar generates a reaction force, which is used to control the payout of the seat belt during an accident. A quantity of the seat belt or webbing 122 (shown in dotted outline) is mounted or rotated onto the spool 106. The spool flanges center the seat belt 122 on the spool.

A seat belt system using the present retractor will include a tongue, which is mounted to the seat belt and a buckle in which the tongue can be locked in place (not shown in the figures). As is known, the retractor 100 can be mounted within a vehicle seat or secured to the floor or one of the pillars of a vehicle.

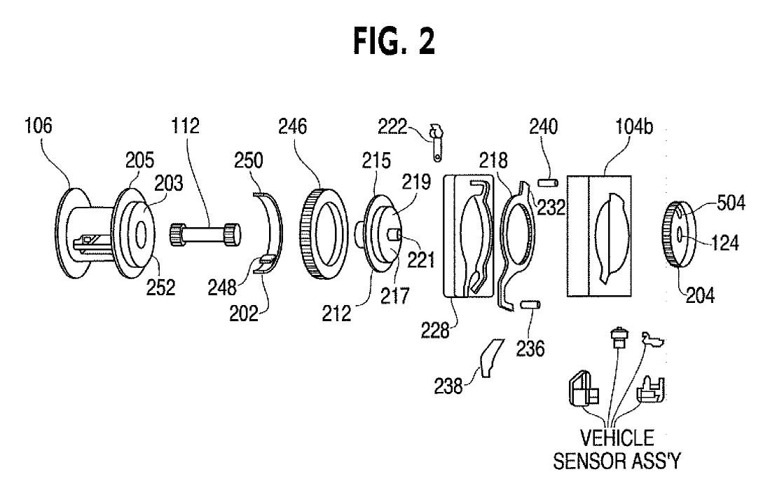

In addition to the torsion bar 112, the retractor 100 also includes a second energy-absorbing mechanism. This second energy-absorbing mechanism can be a pre-bent member 202. FIG. 2 shows the components of the retractor in an exploded view.

The retractor includes a first locking mechanism, or the torsion bar mechanism. As previously mentioned, the torsion bar 112 is connected to the spool 106 through the use of a notched end 114a inserted into a grooved mating hole in the spool. The end 114b of the torsion bar also has notches around its periphery, which is inserted into a grooved mating hole 213 in the lock base 212. This mating of the end 114b and the lock base's mating hole allows the lock base to rotate in unison with the torsion bar 112.

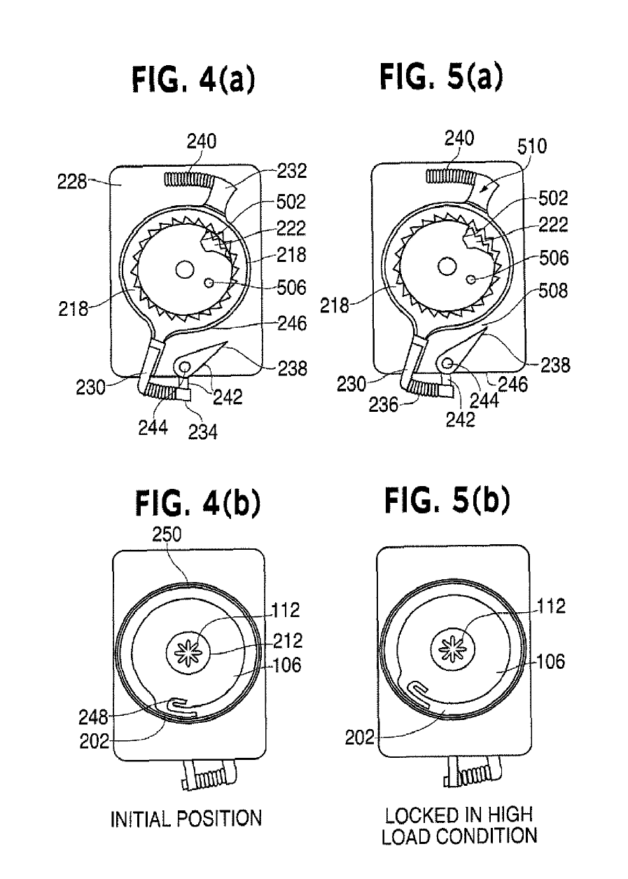

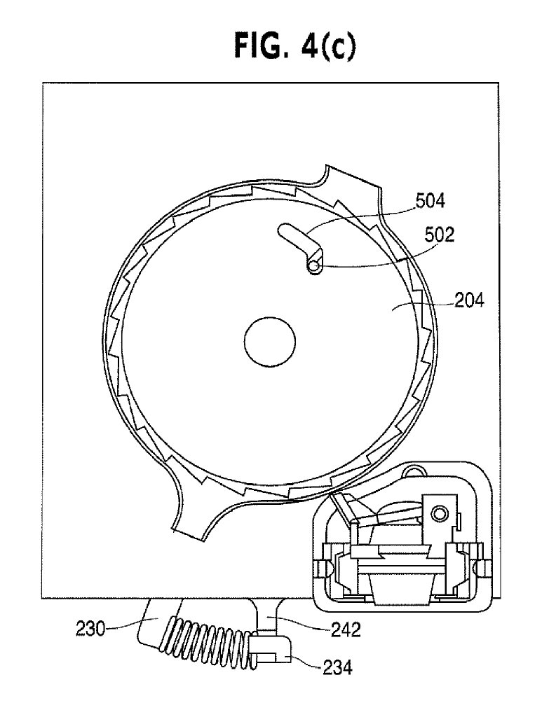

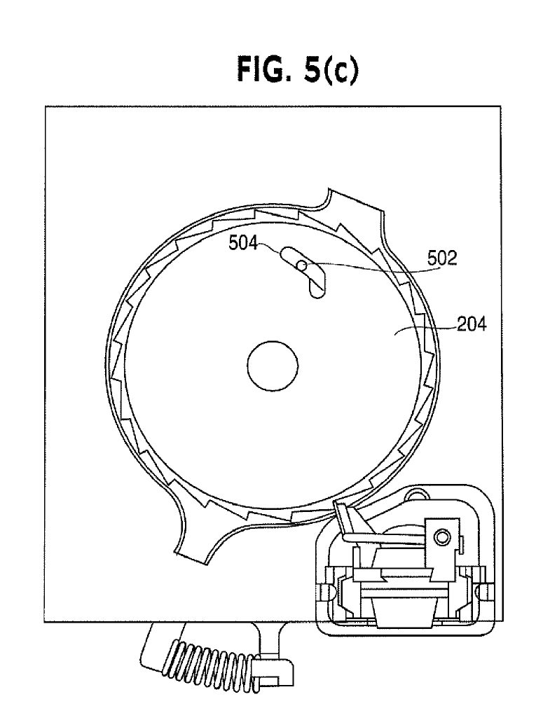

The lock base 212 comprises the mating hole 213, a flange 215, a cylindrical protrusion 217, a notch 219 in the cylindrical protrusion 217, and lock wheel attachment 221. A lock base pawl 222 is attached to the lock base 212 at a pivot 506, as shown in FIG. 4(a). The lock base pawl 222 sits inside notch 219 and includes a post 502 that is inserted into a slot 504 that is located in a lock wheel 204, as shown in FIGS. 2 and 5(c). The lock base pawl 222 is also configured to engage the teeth of a lock ring 218 through the use of at least one tooth. During operation, it is this engagement of the lock ring's teeth with the lock base pawl that causes the torsion bar mechanism to start to yield.

The lock wheel 204 is fastened to the lock base 212 at lock wheel attachment 221 which protrudes through a center opening 124 of the lock wheel. It is noted that the lock wheel 204 is not structural in any way and is only pivotably mounted to the lock base 212. The lock wheel 204 also includes teeth about its periphery, which are configured to be engaged by at least one lock tooth from a lock wheel pawl 310.

A second lock mechanism includes a pre-bent member 202, such as a strip. The pre-bent member 202 is attached to the spool 106 through the hook-shaped end 248 that fits in a corresponding slot 252 in the spool 106. This slot is located at a cylindrical protrusion 203 which extends from a flange 205 of the spool 106. As the one end of the pre-bent member 202 is placed in the slot 252, the other end 250 of the pre-bent member 202 presses against a lock case 246. The lock case 246 covers both the pre-bent member 202 and the spool's cylindrical protrusion 203 and abuts against the spool's flange 205, as seen in FIG. 1. With this arrangement, as the pre-bent member 202 yields during use, it exerts a reaction force against a lug on the inside wall of the lock case 246.

The lock case 246 has teeth around its periphery and they are adapted to be engaged by lever 238. The lever 238 can be engaged to lock case 246 through the use of the lock ring 218. As previously mentioned, the lock ring 218 has teeth on its inner diameter which are adapted to be engaged by the teeth of the lock base lock pawl 222.

The lock ring 218 has two arms 230, 232. The lever arm 230 has a hook-like end 234 and a lever spring 236 fits over it, as depicted in FIG. 4(a). The hook-like end 234 engages a lever arm 242. The lock ring's other arm 232 is pushed by a return spring 240 in a clockwise direction. The lock ring 218 and the return spring 240 fit inside a case guide 228, which includes suitable cut-outs to accommodate the lock ring 218, the return spring 240, and the lever 238. These component are retained in the case guide's cut-outs by the side 104b for frame 102, which abuts the case guide.

As shown in FIG. 4(a), the return spring 240 pushes the arm 232 causing the lock ring 218 to remain in its furthermost clockwise position. In this position, the hook-like end 234 pulls on the lever arm 242 on the lever 238 which, in turn causes the lever 238 to rotate around a pivot 244. Thus, the lever 238 remains unengaged with the teeth of the lock case 246.

The operation of seat belt retractor will now be discussed. The seat belt retractor is switchable from an initial high load to a lower load during a crash event. Both the torsion bar mechanism and the pre-bent member mechanism are engaged for the higher load. The torsion bar mechanism and the pre-bent member mechanism are triggered with the same locking mechanism at about the same time. This mode of operation is used for larger occupants. During lower loads, the pre-bent member mechanism is deactivated. This mode of operation is used for smaller occupants.

FIGS. 4(a)-(c) show the retractor in its initial position before the torsion bar or pre-bent mechanism is engaged. The torsion bar 112 is connected to the lock base 212 on one end and connected to the spool 106 on the other end. During operation, the torsion bar 112, the lock base 212, and the spool 106 rotate together in unison because of the notches in ends 114a, 114b of the torsion bar and the mating holes in the spool 106 and the lock base 212. The lock base pawl 222 rotates with the lock base 212 because of its attachment at pivot 506. Also, the lock wheel 204 rotates with the lock base pawl 222 because of the pawl's post 502 protruding through slot 504. In addition, the pre-bent member 202 spins with the spool 106 due to its attachment to the spool 106 at its hook-like end 248. Thus, because of these interconnections, the torsion bar 112, the lock base 212, the lock wheel 204, the pre-bent member 202, and the lock case 246 all spin in unison with the spool 106.

While these components rotate, the pawl 222 remains unengaged with the lock ring 218. As a result, the lock ring 218 remains in its furthermost clockwise position due to the force of the return spring 240 acting on its arm 232. This position causes the arm 230 to pull lever arm 242 which results in the lever 238 rotating around its pivot 244 in a clockwise fashion. Thus, lever 238 does not engage the lock case 246.

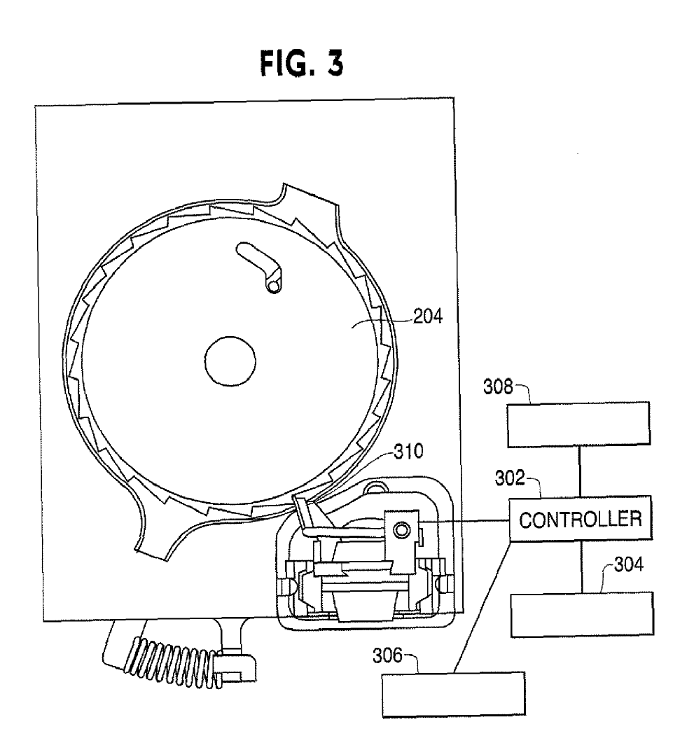

The purpose of the torsion bar and pre-bent member mechanisms is to initiate the lock-up of the retractor in a crash or pending crash. To initiate the use of these mechanisms, a signal is received from at least one sensor placed in the vehicle, which are shown in FIG. 3 as reference numerals 304, 306, and 308. Such sensors can include a vehicle sensor and/or a web sensor but any known vehicle and web sensing mechanisms can be used with the retractor 100. After receiving and processing the signals from one or more sensors 304, 306, and 308, the controller 302 activates the lock wheel pawl 310 to engage the lock wheel 204; thus, stopping the rotation of the lock wheel 204.

Even though the lock wheel 204 has stopped, the spool 106 continues to rotate. As depicted in FIG. 5(a)-(c), as the spool rotates, the pawl post 502 of the lock base pawl 222 rides up the lock wheel's slot 504. As the post 502 slides, the pawl 222 rotates about its pivot 506, which results in the teeth of the pawl 222 engaging the teeth of lock ring 218.

The pawl 222 is the load bearing pawl and once it engages the lock ring 218, it rotates the lock ring counterclockwise against the force of the return spring 240. The lock ring 218 continues to rotate and compressing the spring until the lock ring 218 stops against the edge 510 of the case guide' cut-out. The cessation of rotation of the lock ring 218 has two consequences, which is described below.

The first consequence is that, once the lock ring 218 stops rotating, the lock base 212 stops rotating because it is attached to the pawl 222 at the pawl's pivot 506. Once the lock base 212 has stopped turning, the torsion bar's rotation also stops because of its attachment to the lock base 212 at the mating of end 114b and the mating hole 213. Since the spool 106 is still free to rotate, the torsion bar twists because of its attachment to the spool on the one end and the stopped lock base on the other. This twisting of the torsion bar 112 absorbs the load.

The second consequence is that the rotation of the lock ring 218 causes the lock ring's arm 230 and the lever spring 236 to push the lever arm 242. Because of this pushing from the spring 236, the lever 238 rotates counter-clockwise about its pivot 244, which results in the lever head 508 engaging the lock case 246. With the lever head 508 so engaged, the rotation of the lock case 246 is halted while the spool 106 is still free to rotate.

As previously mentioned, the pre-bent member 202 presses against the lock case 246 at one end and is attached to the spool 106 at the other. Once the lever head 508 is engaged with the lock case 246, pre-bent member 202 exerts a reaction force against the lug on the inside wall of the lock case 246 as the spool continues to spin; thus, causing the pre-bent member to absorb the load. In this position, in order to rotate, the spool must overcome the loads caused by the torsion bar 112 and the pre-bent member 202, i.e., the torsion bar and pre-bent member begin to yield. In effect both the torsion bar and pre-bent members begin yielding at about the same time, or within a few degrees of rotation of the spool.

An occupant classification system of known type provides an output or control signal to identify whether the occupant (using the retractor) is a small (5th percentile) occupant or a larger occupant (greater than 50th percentile). Occupant classification systems while new are generally well known in the art. For example, the occupant classification system can include a weight sensor and associated electronics. Further, the occupant classification system determines that an accident is about to occur (crash sensor, radar or sonar sensors and associated electronics, which may be part of the occupant classification system) or has just begun.

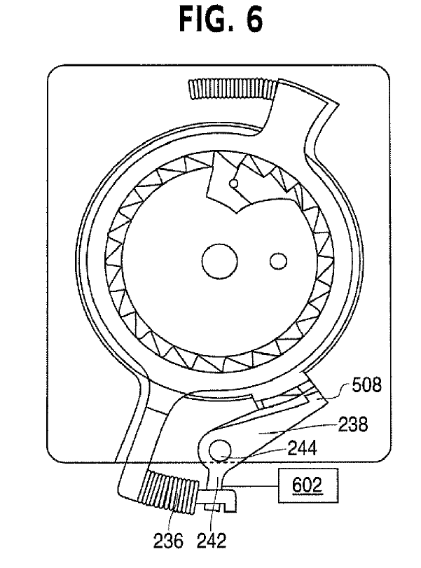

Once the presence of a small occupant is determined, and if the vehicle is involved in an accident, the locking mechanism associated with the pre-bent member mechanism is deactivated by a signal from controller 302. The controller can activate a pyrotechnic unit 602 that applies a force to lever arm 242 which compresses the lever spring 236 and rotates lever 238 clockwise about pivot 244, as shown in FIG. 6. Once the lever pivots, the head of the lever 508 disengages from the teeth of the lock case 246, which allows the lock case to rotate freely in unison with spool 106. Thus, the spool will rotate only against the resistance of the torsion bar 112 since the pre-bent member will not be engaged.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A seat belt retractor, comprising:
a rotatable spool configured to be connected to a seat belt webbing;
a torsion bar connected to the spool at one end and wherein the other end of the bar is configured to be locked in a first fixed position by a locking mechanism;
a sensor for detecting a vehicle characteristic;
a pre-bent member connected to the spool at one end and wherein the other end of the member is configured to be locked in a second fixed position;
wherein the sensor is configured to initiate locking the other end of the torsion bar in the first fixed position; and
wherein the other end of the pre-bent member is configured to be locked in the second fixed position in response to the movement of the torsion bar into the first fixed position by the locking mechanism.

2. The seat belt retractor of claim 1, wherein the pre-bent member is a bending band.

3. The seat belt retractor of claim 1, further comprising a disengagement mechanism configured to prevent the pre-bent member from being locked in the second fixed position when a signal is received from the controller.

4. The seat belt retractor of claim 3, wherein the disengagement mechanism comprises a pyrotechnic device.

5. A seat belt retractor, comprising:
a first and second energy absorption mechanism connected to a spool;
wherein the energy absorption mechanisms are configured to be moved into locked positions; and
wherein one of the first and second energy absorption mechanism is configured to be prevented from being placed in an locked position using a disengagement device when a signal is received from a controller.

6. The seat belt retractor of claim 5, wherein the first energy absorption mechanism is a torsion bar.

7. The seat belt retractor of claim 5, wherein the second energy absorption mechanism is a pre-bent member.

8. The seat belt retractor of claim 5, wherein the pre-bent member is a bending band.

9. A seat belt retractor, comprising:
a first and second energy absorption mechanism connected to a spool;
wherein the first energy absorption mechanism is configured to be moved into a first locked position and the second energy absorption mechanism is configured to be moved into a second locked position in response to the movement of the first energy absorption mechanism into the locked position.

10. The retractor of claim 9, wherein the first energy absorption mechanism includes a locking mechanism including a lock wheel and a lock pawl.

11. The retractor of claim 9, further comprising a pyrotechnic device that activates to prevent the second energy absorption mechanism from moving into the second locked position.
